(19) United States
(12) Patent Application Publication
(10) Pub. No.: US 2011/0219791 A1
(43) Pub. Date: Sep. 15, 2011

(54) COMPOSITION INCLUDING 2,3,3,3-TETRAFLUOROPROPENE, METHOD FOR HEATING AND/OR AIR CONDITIONING A VEHICLE

(75) Inventor: Wissam Rached, Chaponost (FR)

(73) Assignee: Arkema France, Colombes (FR)

(21) Appl. No.: 13/128,996

(22) PCT Filed: Nov. 18, 2009
(86) PCT No.: PCT/FR09/52212

§ 371 Date: May 12, 2011

(30) Foreign Application Priority Data
Nov. 20, 2008 (FR) 08.57882
Mar. 31, 2009 (FR) 09.52043

(51) Int. Cl. F25B 29/00; C09K 5/04; F25B 30/02

(52) U.S. Cl. 62/79; 252/67; 62/238.7

(57) ABSTRACT

The present invention relates to a composition including 2,3,3,3-tetrafluoropropene, difluoromethane and at least one compound chosen among propane, propylene and ethylene, suitable for being used for refrigeration, air-conditioning and heating. The present invention also relates to a method for heating and/or air conditioning the passenger compartment of an automobile using a reversible cooling loop containing a refrigerant including said composition. Said method is particularly suitable when the outside temperature is lower than −20° C. The method is also suitable for hybrid automobiles, which are designed to operate in alternation between a heat engine and an electric engine, as well as for electric vehicles.

The present invention relates to a composition containing 2,3,3,3-tetrafluoropropene, which can be used for refrigeration, air conditioning and for heating, notably in heat pumps.

In motor vehicles, the combustion engine comprises a circuit through which there circulates a heat transfer fluid which is used for cooling the engine and also for heating the cabin. For this purpose, the circuit notably comprises a pump and a unit heater through which there flows a stream of air which recovers the heat stored by the heat transfer fluid in order to heat the cabin.

Moreover, an air conditioning system intended to cool the cabin of a motor vehicle comprises an evaporator, a compressor, a condenser, a pressure regulator and a fluid capable of changing states (between liquid and gas) and commonly known as a refrigerant. The compressor, which is driven directly by the engine of the vehicle using a belt and pulley, compresses the refrigerant, delivering it under high pressure and high temperature to the condenser. The condenser, by forced ventilation, causes the gas arriving in a gaseous state at high pressure and high temperature to condense. The condenser liquefies the gas by lowering the temperature of the air passing through it. The evaporator is a heat exchanger which takes heat energy from the air that is to be blown into the cabin. The pressure regulator regulates the inlet flow rate of gas to the loop by modifying the bore section as a function of the temperature and pressure at the evaporator. Thus, hot air from the outside is cooled as it passes through the evaporator.

The air conditioning system in electric motorcars is a sealed system; the compressor is an electric compressor and the architecture of the system may be confined with an intermediate heat transfer circuit (of the glycol type).

The refrigerant widely used in automotive air conditioning is 1,1,1,2-tetrafluoroethane (HFC-134a).

Document WO 2008/107623 describes a system for managing energy in a motor vehicle comprising a reversible refrigeration loop with the circulation of a refrigerant, means of reversing the operating cycle of the refrigeration loop which are able to move between a refrigeration mode position and a heat pump mode position, at least one first source capable of recovering energy from the refrigerant, and at least one second source able to evaporate the refrigerant following the expansion of said fluid from the liquid state to the diphasic state, the reversal means being capable of causing refrigerant to flow from the first, recovery, source toward at least one evaporation source when they are in a position identical to the position corresponding to the heat pump mode.

However, with HFC-134a as the refrigerant in a system like the one described in document WO 2008/107623, when the outside temperature is around −15° C., a depression begins to form in the evaporator even before the compressor is switched on. This depression, which leads to an ingress of air into the system, encourages corrosion and the degradation of components such as the compressor, the heat exchanger and the pressure regulator.

The objectives of the present invention are to provide a heat transfer fluid and the use thereof, notably by way of refrigerant in a refrigeration loop, that prevent air from entering the evaporator of the refrigeration loop upon compressor start-up and/or that improve the efficiency of the refrigeration loop.

One subject of the present invention is therefore a composition containing 5 to 80 wt % of 2,3,3,3-tetrafluoropropene (HFO-1234yf), 5 to 45 wt % of difluoromethane (HFC-32) and 2 to 50 wt % of at least one group-C compound chosen from propane, propylene and ethylene.

For preference, the composition according to the present invention contains 55 to 75 wt % of 2,3,3,3-tetrafluoropropene, 5 to 40 wt % of difluoromethane and 5 to 40 wt % of at least one group-C compound chosen from propane, propylene and ethylene.

Advantageously, the composition according to the invention contains 60 to 70 wt % of 2,3,3,3-tetrafluoropropylene, 10 to 30 wt % of difluoromethane and 10 to 30 wt % of at least one group-C compound chosen from propane, propylene and ethylene.

The preferred group-C compound is propane.

The composition according to the present invention is more particularly suitable for use as a heat transfer fluid in refrigeration, air conditioning, and for heating.

The composition according to the present invention can be used in refrigeration as a replacement for the current refrigerants such as R-22 (chlorodifluoromethane), R-404A (a mixture consisting of 4 wt % of 1,1,1,2-tetrafluoroethane, 52 wt % of trifluoroethane and 44 wt % of pentafluoroethane) and R-407C (a mixture consisting of 52 wt % of 1,1,1,2-tetrafluoroethane, 23 wt % of difluoromethane and 25 wt % of pentafluoroethane). R-407C is used as a refrigerant in superstores (supermarkets) and refrigerated transportation. However, R-407C has a GWP of 1800.

The contribution that a fluid makes to the greenhouse effect is quantified by a criterion known as the GWP (global warming potential) which sums up its warming potential by taking a reference value of 1 for carbon dioxide.

The composition according to the present invention can also be used in air conditioning, preferably in automotive air conditioning.

The composition according to the present invention can also be used for heating, notably in heat pumps and preferably for heating a motor vehicle cabin.

Thus, one subject of the present invention is a method of heating and/or air conditioning a motor vehicle cabin using a reversible refrigeration loop through which a refrigerant circulates, comprising a first heat exchanger, a pressure regulator, a second heat exchanger, a compressor and means of reversing the direction of flow of the refrigerant, characterized in that the refrigerant comprises the composition as defined hereinabove.

The means of reversing the direction in which the refrigerant flows through the refrigeration loop in order to reverse the operating cycle thereof may consist of a four-way valve.

The refrigerant may also contain 2,3,3,3-tetrafluoropropene stabilizers. Stabilizers may notably include nitromethane, ascorbic acid, terephthalic acid, azoles such as tolutriazole or benzotriazole, phenolic compounds such as tocopherol, hydroquinone, t-butyl hydroquinone, 2,6-di-tert-butyl-4-methylphenol, epoxides (possibly fluorated or perfluorated alkyl epoxides or alkenyl or aromatic epoxides) such as n-butyl glycidyl ether, hexanediol diglycidyl ether, allyl glycidyl ether, butylphenylglycidyl ether, phosphites, phosphates, phosphonates, thiols and lactones.

According to the mode in which the loop is operating, whether as a refrigerator or as a heat pump, the first heat exchanger may act as an evaporator or as an energy recuperator. The same is true of the second heat exchanger. In refrigeration mode, the second exchanger cools the stream of air intended to be blown into the interior of the cabin of the motor vehicle. In heat pump mode, the second exchanger is used to heat up the stream of air intended for the motor vehicle cabin.

The first and second heat exchangers are of the air/refrigerant type. It is also possible to use liquid/refrigerant exchangers so that the liquid acts as an intermediate fluid and transmits energy to the air.

In the method according to the invention, the refrigeration loop may be thermally coupled, through the heat exchangers, to the combustion engine cooling circuit. Thus the loop may comprise at least one heat exchanger through which both the refrigerant and a heat transfer fluid, notably the air or the water from the engine cooling circuit, passes.

According to an alternative form of the method, the first heat exchanger has both the refrigerant and the exhaust gases from the combustion engine of the motor vehicle passing through it; the latter may communicate thermally with a heat transfer fluid circuit.

The refrigeration loop in the method according to the present invention may comprise, as a branch-off, at least one heat exchanger thermally communicating with an air stream intended to be admitted into the combustion engine of the motor vehicle, or with the exhaust gases emanating from the motor vehicle combustion engine.

The method according to the present invention is most especially appropriate when the outside temperature is below −20° C., preferably below −30° C.

The method according to the present invention is also suitable for hybrid motor vehicles which are designed to operate alternately on the engine and on the electric motor. It provides best control over inputs of energy according to climatic Conditions (hot or cold) both in terms of the cabin and in terms of the battery and notably allows the battery to be warmed or cooled through a heat transfer fluid circuit.

The reversible refrigeration loop through which the refrigerant comprising the abovementioned composition flows, which loop is installed in motor vehicles, is especially suitable for recuperating energy from the engine and/or the battery that can be used for heating the cabin and the combustion engine during a cold start phase. This reversible refrigeration loop, when it comprises a pump, can operate in Rankine mode (that is to say that the compressor acts as a turbine) to put the thermal energy produced by the engine and then carried by the refrigerant following heat exchange, to productive use.

Another subject of the invention is a device comprising the refrigeration loop as described hereinabove.

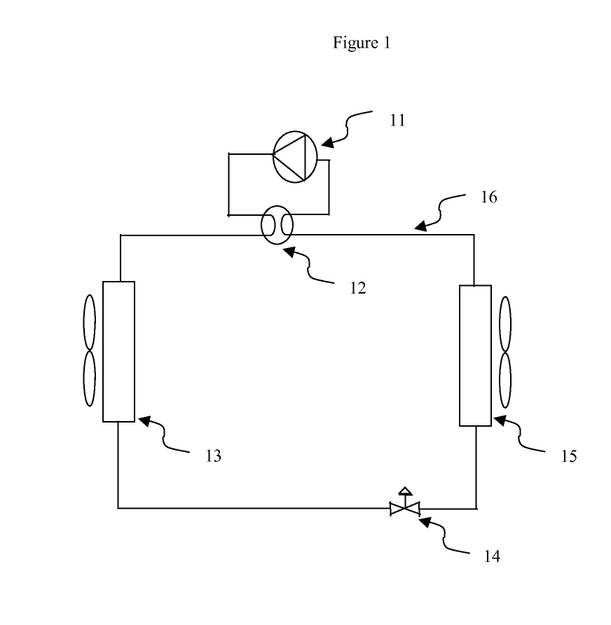

According to a first embodiment of the invention depicted schematically in FIG. 1, the refrigeration loop (16) comprises a first heat exchanger (13), a pressure regulator (14), a second heat exchanger (15), a compressor (11) and a four-way valve (12). The first and second heat exchangers are of the air/refrigerant type. The first heat exchanger (13) has passing through it the refrigerant of the loop (16) and the stream of air created by a fan. All or some of this same air stream also passes through a heat exchanger of the engine cooling circuit (not depicted in the figure). Likewise, the second exchanger (15) has passing through it an air stream created by a fan. All or some of this air stream also passes through another heat exchanger of the engine cooling circuit (not depicted in the figure). The direction in which the air flows is dependent on the mode of operation of the loop (16) and on the requirements of the engine. Thus, when the engine is idle and the loop (16) is in heat pump mode, the air can be heated up by the exchanger of the engine cooling circuit and then blown onto the exchanger (13) to speed up the evaporation of the fluid of the loop (16) and thus improve the performance of this loop.

The exchangers of the cooling circuit may be activated by valves according to engine requirements (heating of the air entering the engine or putting the energy produced by this engine to productive use).

In refrigeration mode, the refrigerant set in motion by the compressor (11) passes, via the valve (12), through the exchanger (13) which acts as a condenser (that is to say gives up heat energy to the outside) then through the pressure regulator (14) then through the exchanger (15) that is acting as an evaporator thus cooling the stream of air intended to be blown into the motor vehicle cabin interior.

In heat pump mode, the direction of flow of the refrigerant is reversed using the valve (12). The heat exchanger (15) acts as a condenser while the exchanger (13) acts as an evaporator. The heat exchanger (15) can then be used to heat up the stream of air intended for the motor vehicle cabin.

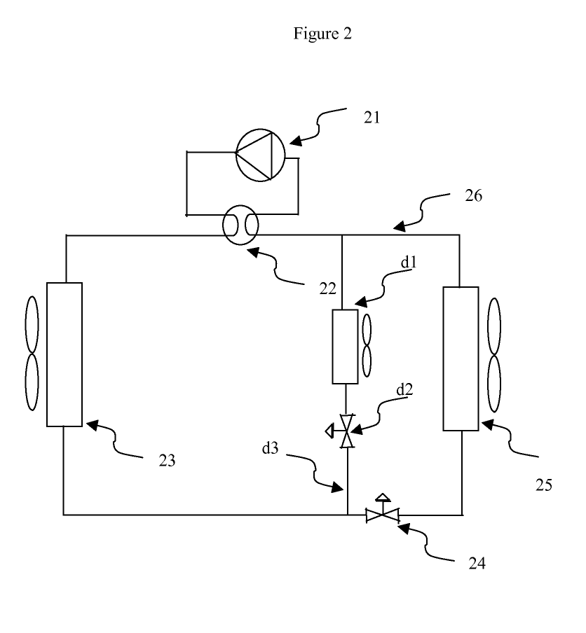

According to a second embodiment of the invention, depicted schematically by FIG. 2, the refrigeration loop (26) comprises a first heat exchanger (23), a pressure regulator (24), a second heat exchanger (25), a compressor (21), a four-way valve (22), and a branch-off (d3) mounted, on the one hand, at the exit of the exchanger (23) and, on the other hand, at the exit of the exchanger (25) when considering the direction of flow of the fluid in refrigeration mode. This branch comprises a heat exchanger (d1) through which there passes a stream of air or stream of exhaust gas which is intended to be admitted to the engine and a pressure regulator (d2). The first and second heat exchangers (23 and 25) are of the air/refrigerant type. The first heat exchanger (23) has passing through it the refrigerant from the loop (26) and the stream of air introduced by a fan. All or some of this same air stream also passes through a heat exchanger of the engine cooling circuit (not depicted in the figure). Likewise, the second exchanger (25) has, passing through it, a stream of air conveyed by a fan. All or some of this air stream also passes through another heat exchanger of the engine cooling circuit (not depicted in the figure). The direction in which the air flows is dependent on the mode of operation of the loop (26) and on the engine requirements. By way of example, when the combustion engine is idle and the loop (26) is in heat pump mode, the air may be heated by the exchanger of the engine cooling circuit and then blown onto the exchanger (23) to accelerate the evaporation of fluid of the loop (26) and improve the performance of this loop.

The cooling circuit exchangers can be activated using valves according to engine requirements (the heating of air entering the engine or putting energy produced by this engine to productive use).

The heat exchanger (d1) may also be activated according to energy requirements, whether this is in refrigeration mode or in heat pump mode. Shut-off valves can be installed on the branch (d3) to activate or deactivate this branch.

A stream of air conveyed by a fan passes through the exchanger (d1). This same air stream may pass through another heat exchanger of the engine cooling circuit and also through other exchangers placed in the exhaust gas circuit, on the engine air inlet or on the battery in the case of hybrid motorcars.

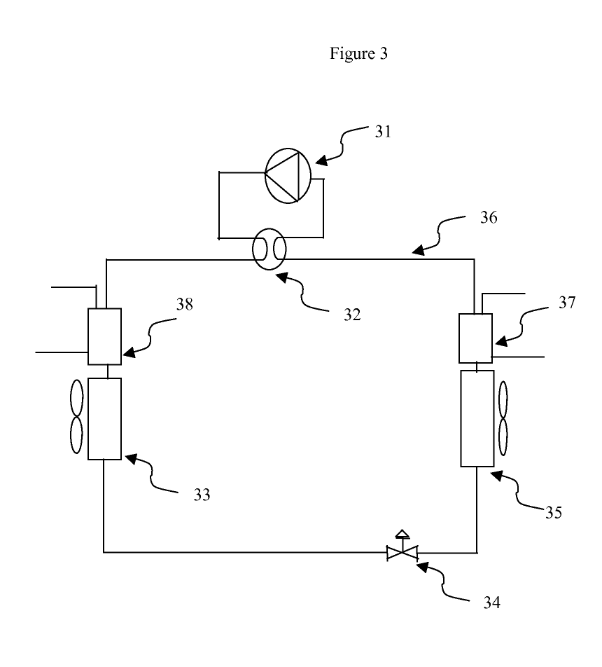

According to a third embodiment of the invention, depicted schematically in FIG. 3, the refrigeration loop (36) comprises a first heat exchanger (33), a pressure regulator (34), a second heat exchanger (35), a compressor (31) and a four-way valve (32). The first and second heat exchangers (33 and 35) are of the air/refrigerant type. The way in which the exchangers (33 and 35) operate is the same as in the first embodiment depicted in FIG. 1. Two fluid/liquid exchangers (38 and 37) are installed both on the refrigeration loop circuit (36) and on the engine cooling circuit or on a secondary glycol-water circuit. Installing fluid/liquid exchangers without going through an intermediate gaseous fluid (air) contributes to improving heat exchange by comparison with air/fluid exchangers.

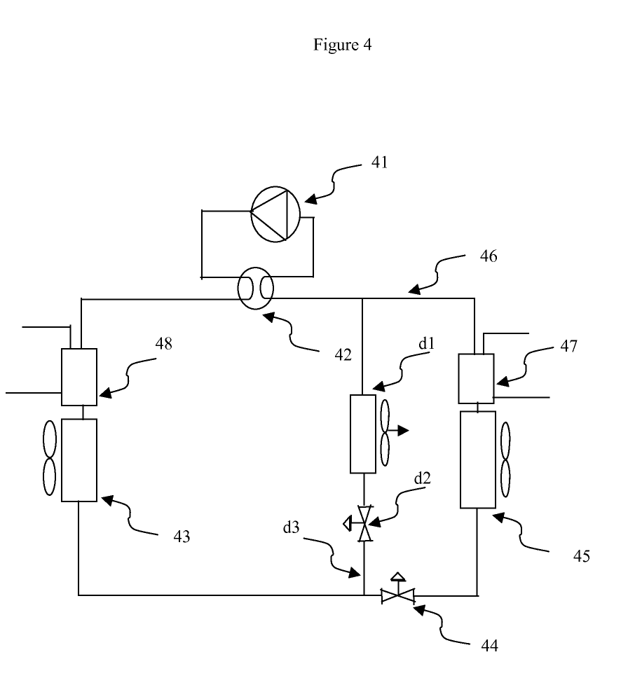

According to a fourth embodiment of the invention depicted schematically in FIG. 4, the refrigeration loop (46) comprises a first series of heat exchangers (43 and 48), a pressure regulator (44), a second series of heat exchangers (45 and 47), a compressor (41) and a four-way valve (42). A branch-off (d1) mounted, on the one hand, at the exit of the exchanger (43) and, on the other hand, at the exit of the exchanger (47), when considering the circulation of the fluid in refrigerant mode. This branch comprises a heat exchanger (d1) through which there passes a stream of air or a stream of exhaust gases intended to be admitted to a combustion engine and a pressure regulator (d2). The way in which this branch operates is the same as in the second embodiment depicted in FIG. 2.

The heat exchangers (43 and 45) are of the air/refrigerant type and the exchangers (48 and 47) are of the liquid/refrigerant type. The way in which these exchangers work is the same as in the third embodiment depicted in FIG. 3.

The method according to the present invention is also suitable for electric motor vehicles which are designed to operate on a battery. It is able to provide better control over the inputs of energy to suit the climatic conditions (hot or cold) both in terms of the cabin and in terms of the battery and notably is able to warm or cool the battery through a heat transfer fluid circuit.

### EXPERIMENTAL PART

Simulations of the performance of the refrigerant under heat pump operating conditions in vehicles by setting the condenser temperature to 30° C. are given below.

Condensation temperature: +30° C. (T cond)

Compressor inlet temperature: +5° C. (Ti comp)

Evaporator outlet temperature: −30° C. (To evap)

Evap P: is the pressure at the evaporator

Cond P: is the pressure at the condenser

To comp: is the temperature at the compressor outlet

Ratio: The compression ratio is the ratio of the high pressure to the low pressure.

COP: Coefficient of performance defined, in the case of a heat pump, as the useful hot power supplied by the system to the power supplied to or consumed by the system.

CAP: Volumetric capacity, is the specific heat capacity per unit volume (kJ/m³)

% CAP or COP is the ratio of the value of the CAP or COP of the composition according to the present invention with respect to that of R-407C

Isentropic efficiency of the compressor: is the ratio between the actual energy transmitted to the fluid and the isentropic energy.

The isentropic efficiency of the compressor is considered to be equal to 0.7.

| | | | Tl evap | To evap | Tcond | | evap P | cond P | Ratio | To | CAP | % | % |
|---|---|---|---|---|---|---|---|---|---|---|---|---|---|
| | | | (° C.) | (° C.) | (° C.) | Slip | (kPa) | (kPa) | (p/p) | comp | (kJ/m³) | cap | COP |
| R407C | | | −35 | −30 | 30 | 5 | 139 | 1370 | 9.8 | 85 | 1293 | 100 | 100 |
| A | B | C | | | | | | | | | | | |
| 70 | 25 | 5 | −37 | −30 | 30 | 7 | 161 | 1560 | 9.7 | 108 | 1539 | 119 | 111 |
| 70 | 20 | 10 | −38 | −30 | 30 | 8 | 165 | 1557 | 9.5 | 103 | 1519 | 117 | 109 |
| 70 | 15 | 15 | −38 | −30 | 30 | 8 | 167 | 1508 | 9.0 | 98 | 1500 | 116 | 110 |
| 70 | 10 | 20 | −36 | −30 | 30 | 6 | 169 | 1419 | 8.4 | 91 | 1478 | 114 | 111 |
| 70 | 5 | 25 | −35 | −30 | 30 | 5 | 170 | 1292 | 7.6 | 84 | 1451 | 112 | 115 |
| 65 | 25 | 10 | −38 | −30 | 30 | 8 | 177 | 1650 | 9.3 | 107 | 1634 | 126 | 109 |
| 65 | 20 | 15 | −38 | −30 | 30 | 8 | 180 | 1618 | 9.0 | 102 | 1616 | 125 | 109 |
| 65 | 15 | 20 | −37 | −30 | 30 | 7 | 183 | 1550 | 8.5 | 96 | 1595 | 123 | 110 |
| 65 | 10 | 25 | −35 | −30 | 30 | 5 | 183 | 1448 | 7.9 | 90 | 1570 | 121 | 113 |
| 65 | 5 | 30 | −33 | −30 | 30 | 3 | 183 | 1313 | 7.2 | 83 | 1535 | 119 | 117 |
| 60 | 25 | 15 | −38 | −30 | 30 | 8 | 194 | 1713 | 8.8 | 105 | 1735 | 134 | 109 |
| 60 | 20 | 20 | −37 | −30 | 30 | 7 | 197 | 1662 | 8.5 | 100 | 1716 | 133 | 110 |
| 60 | 15 | 25 | −36 | −30 | 30 | 6 | 198 | 1580 | 8.0 | 95 | 1692 | 131 | 111 |
| 60 | 10 | 30 | −34 | −30 | 30 | 4 | 196 | 1469 | 7.5 | 89 | 1658 | 123 | 114 |
| 60 | 5 | 35 | −32 | −30 | 30 | 2 | 193 | 1328 | 6.9 | 82 | 1609 | 124 | 118 |
| 55 | 25 | 20 | −37 | −30 | 30 | 7 | 211 | 1758 | 8.3 | 103 | 1842 | 142 | 110 |
| 55 | 20 | 25 | −36 | −30 | 30 | 6 | 212 | 1693 | 8.0 | 98 | 1817 | 141 | 111 |
| 55 | 10 | 35 | −33 | −30 | 30 | 3 | 207 | 1484 | 7.2 | 88 | 1729 | 134 | 116 |
| 55 | 5 | 40 | −32 | −30 | 30 | 2 | 200 | 1337 | 6.7 | 82 | 1659 | 128 | 120 |

A: 2,3,3,3-tetrafluoropropene
B: difluoromethane
C: propane

The quantities indicted in columns A, B and C are given in percentages by weight.

1. A composition containing 5 to 80 wt % of 2,3,3,3-tetrafluoropropene, 5 to 45 wt % of difluoromethane and 2 to 50 wt % of at least one group-C compound selected from the group consisting of propane, propylene and ethylene.

2. The composition as claimed in claim 1, characterized in that it contains 55 to 75 wt % of 2,3,3,3-tetrafluoropropylene, 5 to 40 wt % of difluoromethane and 5 to 40 wt % of at least one group-C compound selected from the group consisting of propane, propylene and ethylene.

3. The composition as claimed in claim 1, characterized in that it contains 60 to 70 wt % of 2,3,3,3-tetrafluoropropylene, 10 to 30 wt % of difluoromethane and 10 to 30 wt % of at least one group-C compound selected from the group consisting of propane, propylene and ethylene.

4. A method of heating and/or air conditioning a motor vehicle cabin comprising circulating a refrigerant through a first heat exchanger, a pressure regulator, a second heat exchanger, a compressor and reversing the direction of flow of the refrigerant, characterized in that the refrigerant comprises a composition containing 5 to 80 wt % of 2,3,3,3-tetrafluoropropene, 5 to 45 wt % of difluoromethane and 2 to 50 wt % of at least one group-C compound selected the group consisting of propane, propylene and ethylene.

5. The method as claimed in claim 4, characterized in that the first and second exchangers are air/refrigerant type heat exchangers.

6. The method as claimed in claim 4, characterized in that the first and second exchangers are liquid/refrigerant type heat exchangers and further comprising transmitting energy to the air intended for the cabin using a secondary circuit.

7. The method as claimed in claim 4, characterized in that the refrigeration loop is thermally coupled to the combustion engine cooling circuit of said motor vehicle.

8. The method as claimed in claim 4, characterized in that the first heat exchanger has both refrigerant and exhaust gases from the combustion engine of the motor vehicle passing through it.

9. The method as claimed in claim 4, further characterized in at least one heat exchanger thermally communicating with an air stream admitted into the combustion engine of the motor vehicle, or with the exhaust gases emanating from the motor vehicle combustion engine.

10. The method as claimed in claim 4, further characterized in recuperating energy from the combustion engine and/or from the electric battery of the motor vehicle.

11-13. (canceled)

14. A device for heating and/or air conditioning a motor vehicle cabin comprising a first heat exchanger, a pressure regulator, a second beat exchanger, a compressor and means of reversing the direction of flow of the refrigerant, characterized in that the refrigerant comprises 5 to 80 wt % of 2,3,3,3-tetrafluoropropene, 5 to 45 wt % of difluoromethane and 2 to 50 wt % of at least one group-C compound selected the group consisting of propane, propylene and ethylene.
